(19) United States
(12) Patent Application Publication
(10) Pub. No.: US 2014/0174786 A1
(43) Pub. Date: Jun. 26, 2014

(54) INJECTION MOLDING DEVICE FOR WRAPPING WIRES WITH THREE-COLOR SPIRAL INSULATION LAYERS AND THREE-COLOR WIRES

(71) Applicant: Lorom Precision Industry (Shen Zhen) Co., Ltd., Shenzhen (CN)

(72) Inventors: Yongjun Fu, Shenzhen (CN); Zangyong Liang, Shenzhen (CN); Cangcai Wang, Shenzhen (CN); Guohong Chen, Shenzhen (CN)

(73) Assignee: Lorom Precision Industry (Shen Zhen) Co., Ltd., Shenzhen (CN)

(21) Appl. No.: 14/097,053

(22) Filed: Dec. 4, 2013

(30) Foreign Application Priority Data
Dec. 24, 2012 (CN) 201220718109.5
Apr. 12, 2013 (CN) 201320183528.8

(51) Int. Cl. H01B 7/36; B29C 45/16

(52) U.S. Cl. CPC H01B 7/361; B29C 45/1606
USPC 174/110 R; 425/505

(57) ABSTRACT

The present invention discloses an injection molding device for wrapping wires with three-color spiral insulation layers and three-color wires. The injection molding device comprises: a spinning block, a fixed mould, and a handpiece that are coaxially mounted. Each of the axes of these three components is provided with a center bore. The third plastic feeding pipe is arranged between the side wall of the handpiece and the center bore; a first plastic feeding pipe and a second plastic feeding pipe are arranged between the side wall of the fixed mould and the front end face thereof. This injection molding device is used to wrap wires up with three-color insulation layers. Three-color spiral wires are easy to identify and operate.

### RELATED APPLICATIONS

This application claims priority to Chinese Application Serial Number 201220718109.5, filed Dec. 24, 2012 and 201320183528.8, filed Apr. 12, 2013, which is incorporated by reference herein in its entirety.

### TECHNICAL FIELD

The present invention relates to an injection molding device, and more specifically to an injection molding device for wrapping wires with three-color spiral insulation layers and three-color wires.

### BACKGROUND

Wires and the related insulation layers available on the market are single-colored or double-colored, which limits the identification. A three-color spiral wire will facilitate identification; enhance aesthetic, and increase product sales capability and competitiveness. Therefore, developing an injection molding device that is used to produce three-color spiral wires is an urgent technical issue to be resolved.

### SUMMARY

The purpose of the present invention is to address technical problems in the prior art. Embodiments of the present invention provide an injection molding device for wrapping wires with three-color spiral insulation layers and three-color wires.

To address the above technical problems, an embodiment of the present invention provides an injection molding device for wrapping wires with three-color spiral insulation layers, comprising a spinning block, a fixed mould, and a handpiece that are coaxially mounted. Each of the axes of these three components is provided a center bore for wires passing through. The spinning block is entangled by a mould temperature cap. The rear end of the mould temperature cap is coupled to the outer periphery of the fixed mould. The front end of the spinning block goes through the front end of the mould temperature cap and the outer periphery of the spinning block is socketed by a gear. A bearing is arranged between the mould temperature cap and the spinning block. The spinning block rotates around the axes with the rotation of the gear; a third plastic feeding pipe is arranged between the side wall of the handpiece and the center bore; a first plastic feeding pipe and a second plastic feeding pipe are arranged between the side wall of the fixed mould and the front end face thereof; the rear end of the spinning block is provided with a first carrier ring that is coupled to the first plastic feeding pipe and the second carrier ring that is coupled to the second plastic feeding pipe; a first feeding channel is arranged between the first carrier ring and the center bore at the axes of the spinning block; a second feeding channel is arranged between the second carrier ring and the center bore at the axes of the spinning block.

The handpiece comprises a coaxially-mounted movement, an internal mould, and a handpiece body that is socketed on the movement outer periphery. The wire goes through the axes of these three components, wherein the center of the movement is a round bore, the outer periphery of the movement is conical, the front end of the movement is small and the rear end of the movement is large, the front end of the movement and the internal mould are in a thread joint structure; the center of the internal mould is a conical bore, the outer periphery is conical, the front end of the internal mould is small and the rear end of the internal mould is large, the internal mould is inserted in the fixed mould; the inner periphery of the handpiece body is a conical bore that mates with the outer periphery of the movement, the outer periphery of the main part is square, the side wall of the handpiece body is provided with a third feeding inlet that is coupled to the third plastic feeding pipe; a space is reserved between the inner periphery of the handpiece body and the outer periphery of the movement; a space is reserved between the inner periphery of the fixed mould and the outer periphery of the internal mould; two spaces form the third plastic feeding pipe.

The center of the fixed mould is a conical bore that mates with the outer periphery of the internal mould; the outer periphery of the fixed mould is cylindric, the side wall is provided with the first feeding inlet that is coupled to the first plastic feeding pipe and the second feeding inlet that is coupled to the second plastic feeding pipe; the front end of the fixed mould is provided with a circinate step boss; the outside of the step boss is provided with a tubular check ring; a circinate plane is reserved between the step boss and the check ring, and the outlet of the first plastic feeding pipe is arranged on the circinate plane; the outlet of the second plastic feeding pipe is arranged on the step surface of the step boss; the center of the step boss is the center bore which the wires pass through.

The spinning block comprises a carrier disc and a nozzle, wherein, the main part of the carrier disc is cylindric; the rear end is provided with a cylindric plug that can be inserted into the check ring; the center of the plug is provided with a step bore that mates with the step boss; the end face of the plug is provided with a plurality of circularly-arranged first carrier rings that are coupled to the outlet of the first plastic feeding pipe; the step surface of the plug is provided with a plurality of circularly-arranged second carrier rings that are coupled to the outlet of the second plastic feeding pipe; the center of the plug is provided with a center bore that is coupled to the center bore of the fixed mould; the inner of the carrier disc is provided with the first runner that is in communication with the front end face of the carrier disc and the first carrier ring, and the inner of the carrier disc is provided with the second runner that is in communication with the front end face of the carrier disc and the second carrier ring; the rear end of the nozzle is a thick and flat cylinder; the rear end face is dimpling in, to inlay the carrier disc; the rear of the nozzle is provided with a cambered first runner trough that is coupled to the outlet of the first runner and a cambered second runner trough that is coupled to the outlet of the second runner; the center of the nozzle is coupled to the center bore of the carrier disc; the first runner trough and the second runner trough are provided with grooves that are coupled to the center bore of the nozzle; the front end of the nozzle is a vimineous cylinder that goes through the outside of the mould temperature cap, and the outer periphery is socketed with the gear; the first carrier ring, the first runner, the first runner trough, and grooves form the first feeding channel, and the second carrier ring, the second runner, the second runner trough, and grooves form the second feeding channel.

The side wall of the mould temperature cap is provided with the pipeline that is used for circulating hot oil.

The bearing comprises a tapered roller bearing, the first thrust ball bearing, and the second thrust ball bearing; the first thrust ball bearing is fixed between the front end face of the fixed mould and the rear end face of the spinning block; the tapered roller bearing is fixed between the inner side wall of the mould temperature cap and the outer side wall at the front end of the nozzle; the second thrust ball bearing is fixed between the front end face at the rear end of the nozzle and the rear end face of the tapered roller bearing.

The inner wall at the rear end of the mould temperature cap and the outer periphery of the fixed mould are provided with threads and are thread jointed together; the outer periphery of the fixed mould is thread jointed with a mould clamping ring; the mould clamping ring tightly abuts against the rear end face of the mould temperature cap.

The first feeding inlet and the second feeding inlet are provided with female threads.

An embodiment of the present invention also provides a three-color spiral wire that is fabricated by the injection mould device, comprising an enamelled wire set and an insulation layer outside the enamelled wire set, wherein the insulation layer is spirally winded around as a cylinder by three-color insulation materials.

The insulation material outside the enamelled wire set is a thermoplastic material.

The enamelled wire set is solid or tubular copper wires, tinned copper wires, or multiple twisted thin copper wires.

The present invention can wrap wires up with three-color spiral insulation layers. Three-color wires can facilitate identification, enhance aesthetic, and increase product sales capability and competitiveness. The injection molding device proposed in the present invention is easy to operate and maintain and has wide market prospect.

### BRIEF DESCRIPTION OF THE DRAWINGS

The present invention is described in detail with reference to accompanying drawings and specific embodiments, wherein,

FIG. 1 is a longitudinal section view of an injection molding device according to the present invention;

FIG. 2 is a disassembled view of main parts of the injection molding device according to the present invention;

FIG. 3 is a transverse section view of a three-color wire according to the present invention;

FIG. 4 is an exterior view of the three-color wire according to the present invention;

FIG. 5 is a front view of a fixed mould according to the present invention;

FIG. 6 is a section view of the fixed mould according to the present invention;

FIG. 7 is a stereo view of the fixed mould according to the present invention;

FIG. 8 is a section view of a carrier disc according to the present invention;

FIG. 9 is a front view of the carrier disc according to the present invention;

FIG. 10 is a front view of a nozzle according to the present invention;

FIG. 11 is a second view of the nozzle according to the present invention; and

FIG. 12 is a schematic view of the connection between the carrier disc and the nozzle according to the present invention.

### DETAILED DESCRIPTION

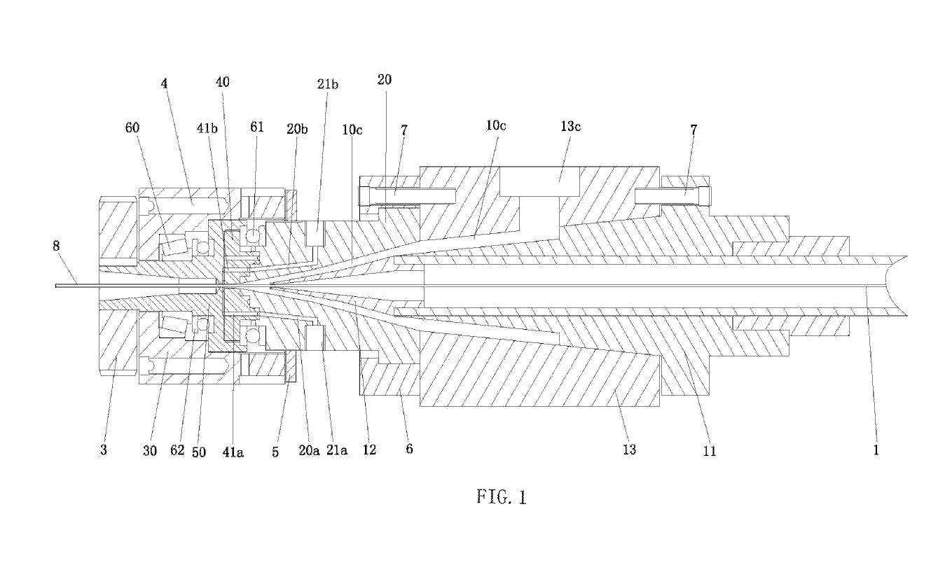

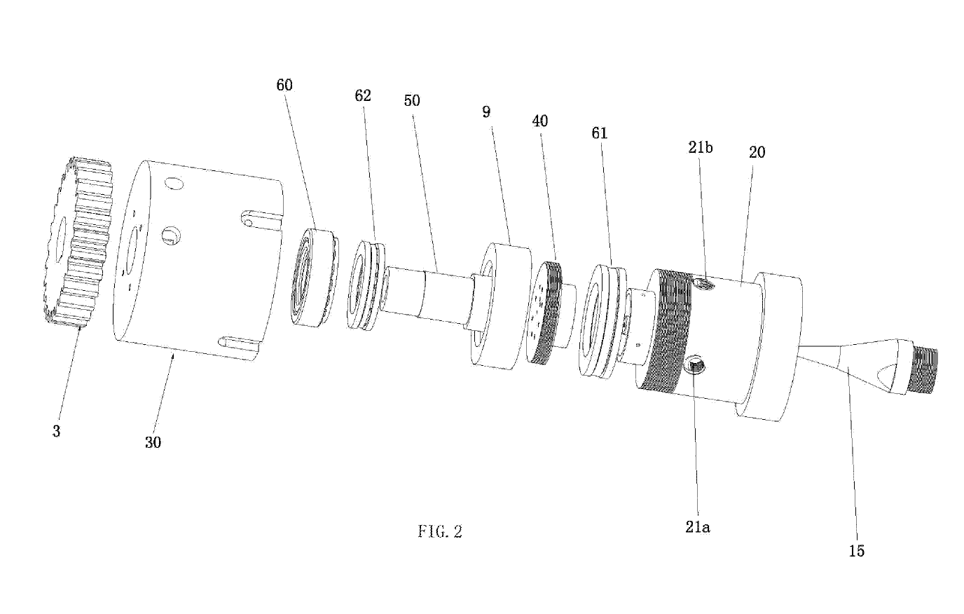

The present invention proposes an injection molding device for wrapping wires with three-color spiral insulation layers and three-color wires. The injection molding device comprises a spinning block 9, a fixed mould 20, and a handpiece 15 that are coaxially mounted. Referring to FIG. 1 and FIG. 2, each of the axes of these three components is provided with a center bore for a wire 1 to pass through. The spinning block 9 is entangled by a mould temperature cap 30. The rear end of the mould temperature cap 30 is coupled to the outer periphery of the fixed mould 20. The front end of the spinning block 9 goes through the front end of the mould temperature cap 30 and the outer periphery of the spinning block 9 is socketed by a gear 3. A bearing is arranged between the mould temperature cap 30 and the spinning block 9. The spinning block 9 rotates around the axes with the rotation of the gear 3. The third plastic feeding pipe 10c is arranged between the side wall of the handpiece 15 and the center bore thereof; the first plastic feeding pipe 20a and the second plastic feeding pipe 20b are arranged between the side wall of the fixed mould 20 and the front end face thereof; the spinning block 9 comprises a carrier disc 40 and a nozzle 50. The rear end face of the carrier disc 40 is provided with the first carrier ring 40a that is coupled to the first plastic feeding pipe 20a and the second carrier ring 40b that is coupled to the second plastic feeding pipe 20b; a first feeding channel is arranged between the first carrier ring 40a and the center bore at the axes of the spinning block 9; a second feeding channel is arranged between the second carrier ring 40b and the center bore at the axes of the spinning block 9.

It should be noted that, wire 1 can be solid or tubular copper wires, tinned copper wires, or multiple twisted thin copper wires as an enamelled wire set. The plastics are insulation materials, generally the thermoplastic plastics, for example, thermoplastic elastomer (TPE), polyethylene (PE), and polypropylene (PP). The initial state of the plastics is granular. After plastics are heated by the heating cylinder, the plastics become thick and viscous fluid sizing materials and are pressed into a feeding inlet under the action of a forcing screw (not shown in the figures). Three feeding inlets are available for pressing plastics of three different colors respectively. The inner layer of a processed three-color spiral wire is an enamelled wire set, the outside is an insulation layer that is wrapped up by the enamelled wire set, and the insulation layer is spirally winded around as a cylinder by three-color insulation materials.

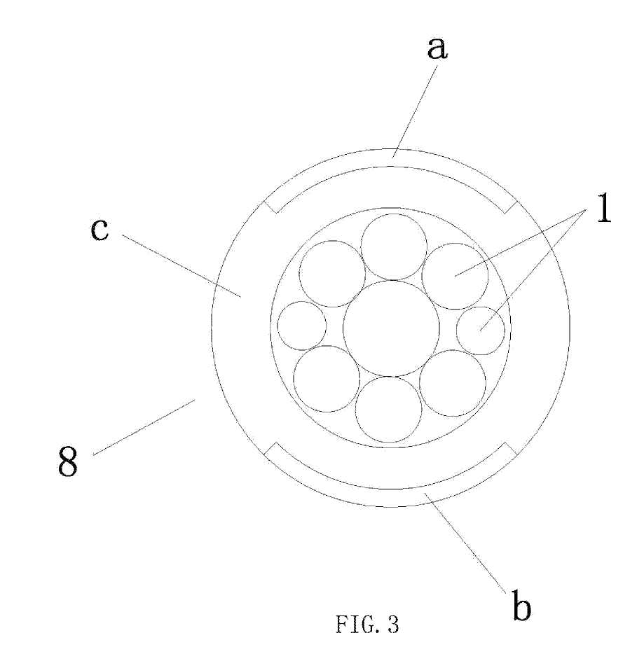

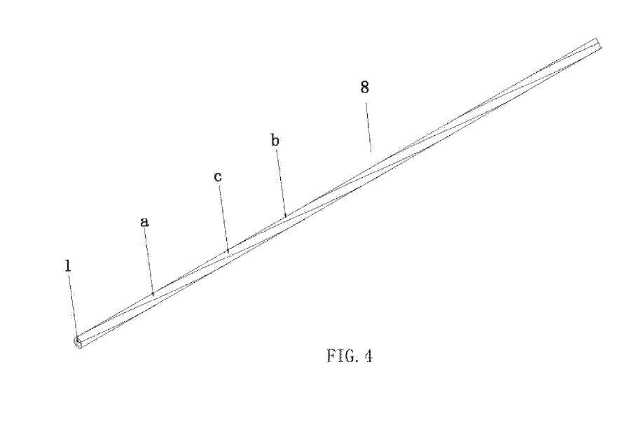

Referring to FIG. 1, the wire is dragged by a tractor and moves to the left, the fixed mould 20 and handpiece 15 do not move, and the spinning block 9 rotates at a constant speed under the driven force by the gear 3. The first plastics are pressed into the center bore 2 to wrap the wire in axial motion over the third plastic feeding pipe 10c on the handpiece 15, and this plastic layer is not spiral; the first and second plastics are pressed into the device over the first plastic feeding pipe 20a and the second plastic feeding pipe 20b of the fixed mould 20; the first carrier ring 40a and the second carrier ring 40b at the rear end of the spinning block 9 are annular and continuously convey fluid materials during the rotation of the spinning block 9; first and second plastics are conveyed to the center bore of the spinning block 9 through first and second feeding channels that are coupled to the first and second carrier rings 40a and 40b and are pressed on two sides of the third plastic; due to the uniform rotation of the spinning block, the finished wires are spirally twisted up on the third plastic. FIG. 3 shows the lateral section view of the finished three-color wire 8. FIG. 4 shows the exterior of the finished three-color wire 8. In the two figures, icons a, b, and c represent the first plastic, the second plastic, and the third plastic respectively.

Referring to the preferred embodiment illustrated in FIG. 1, the handpiece 15 comprises a coaxially-mounted movement 11, internal mould 12, and a handpiece body 13 that is socketed on the movement outer periphery. The wire goes through the axes of these three components, wherein the center of the movement 11 is a round bore, the outer periphery is conical, the front end of the movement 11 is small and the rear end of the movement is large, the front end of the movement 11 and the internal mould 12 are in a thread joint structure; the center of the internal mould 12 is a conical bore, the outer periphery is conical, the front end of the internal mould 12 is small and the rear end of the internal mould 12 is large, the internal mould 12 is inserted in the fixed mould 20; the inner periphery of the handpiece body 13 is a conical bore that mates with the outer periphery of the movement 11, the outer periphery of the handpiece body 13 is square, the side wall of the handpiece body 13 is provided with a third feeding inlet 13c that is coupled to the third plastic feeding pipe 20b; a space is reserved between the inner periphery of the handpiece body 13 and the outer periphery of the movement 11; a space is reserved between the inner periphery of the fixed mould 20 and the outer periphery of the internal mould 12; two spaces form the third plastic feeding pipe 10c. In this embodiment, the right side of the movement 11 is provided with a plurality of circularly-arranged swelled fixed rings. The ring is provided with a through-hole. The mounting screw 7 is fixed on the handpiece body 13 over the movement 11.

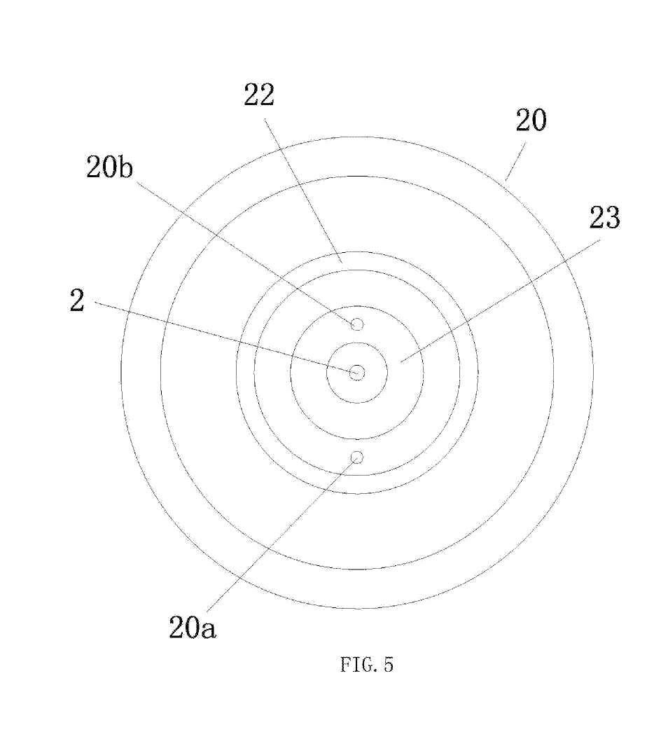

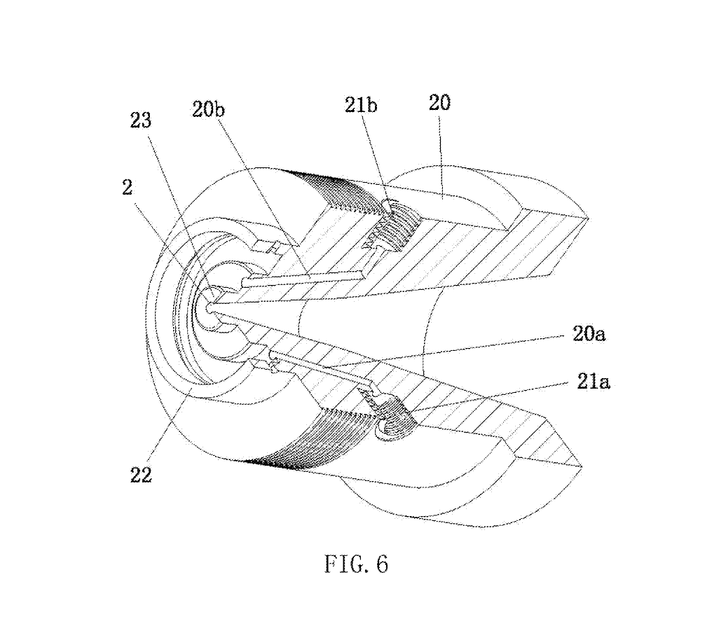

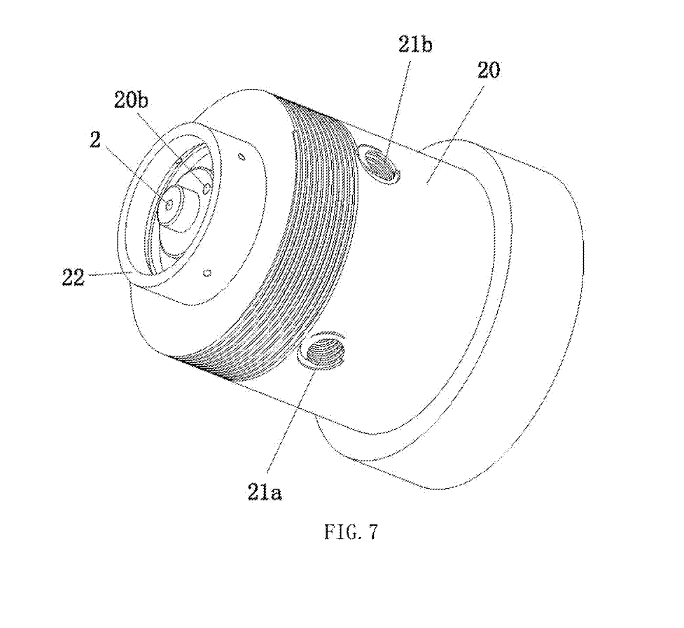

FIG. 5, FIG. 6, and FIG. 7 show the front view, section view, and stereo view of the fixed mould 20 in a preferred embodiment. The center of the fixed mould 20 is a conical bore that mates with the outer periphery of the internal mould 12; the outer periphery of the fixed mould 20 is cylindric, the side wall is provided with a first feeding inlet 21 a that is coupled to the first plastic feeding pipe 20a and a second feeding inlet 21b that is coupled to the second plastic feeding pipe 20b; the front end of the fixed mould 20 is provided with a circinate step boss 23 (FIG. 6); the outside of the step boss 23 is provided with a tubular check ring 22; a circinate plane is reserved between the step boss 23 and the check ring 22, and the outlet of the first plastic feeding pipe 20a is arranged on the circinate plane; the outlet of the second plastic feeding pipe 20b is arranged on the step surface of the step boss; the center of the step boss 23 is the center bore 2 which the wires pass through. The right side of the fixed mould 20 is provided with a plurality of circularly-arranged swelled fixed rings. An outer square and inner annular fixed clamp 6 fixes the fixed ring (the fixed mould 20) on the left end face of the handpiece body 13. The fixed clamp 6 and the handpiece body 13 are fixed by using a mounting screw 7.

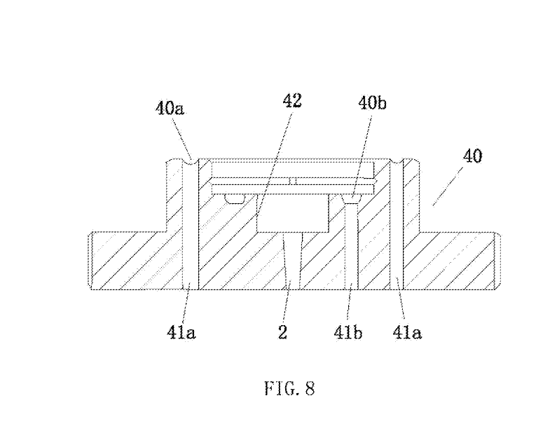

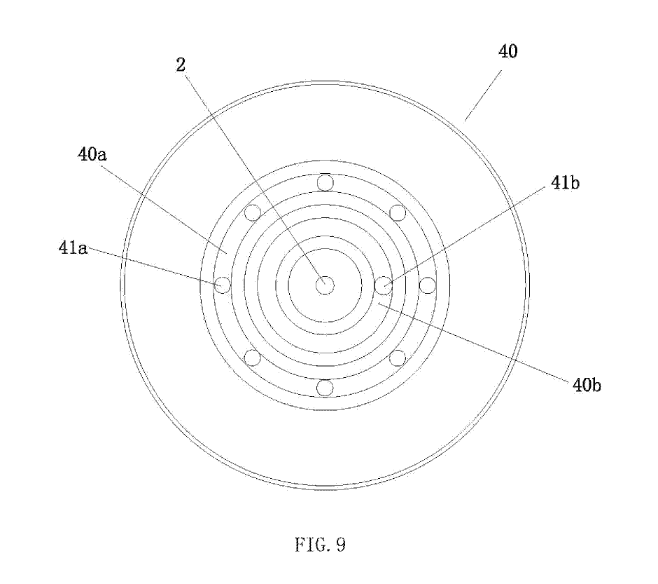

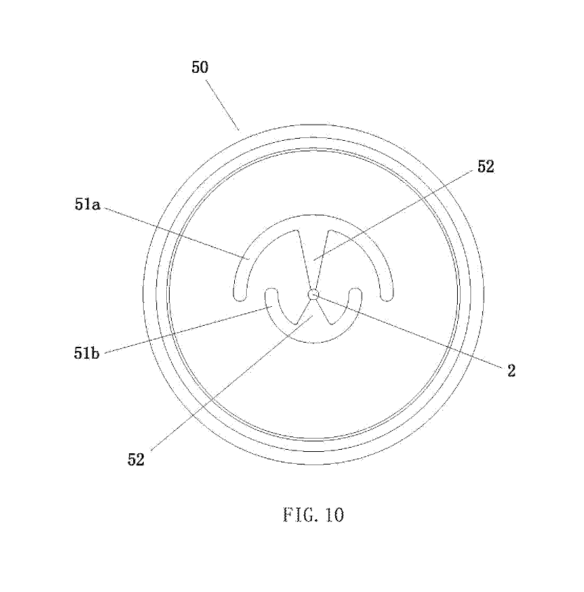

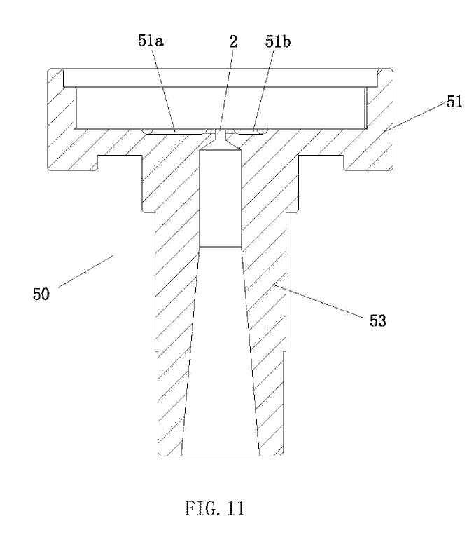

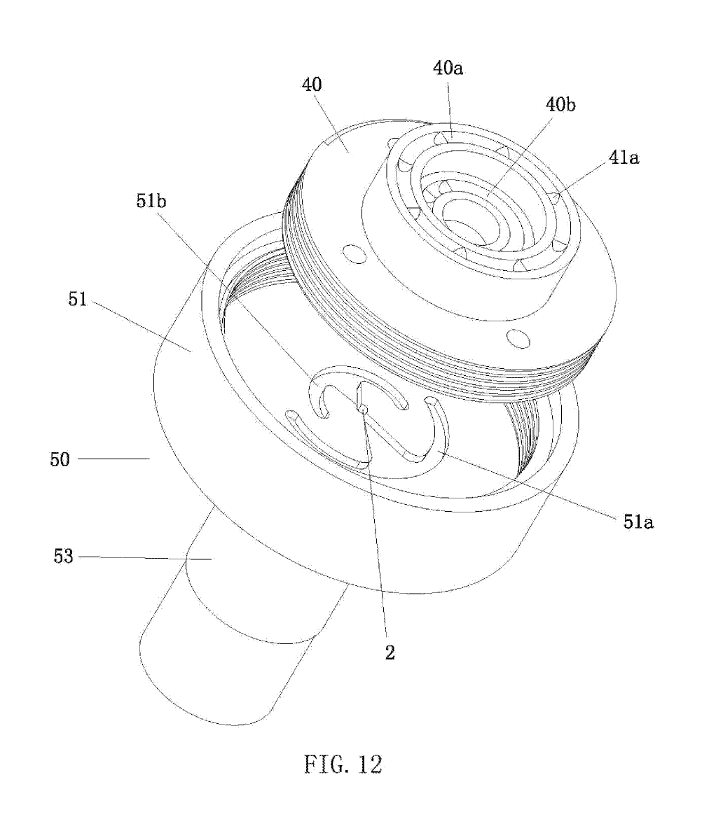

In a preferred embodiment, the spinning block 9 comprises the carrier disc 40 and the nozzle 50. Referring to the section view and front view of the carrier disc in FIG. 8 and FIG. 9, the main part of the carrier disc 40 is cylindric; the rear end is provided with a cylindric plug that can be inserted into the check ring 22; the center of the plug is provided with a step bore 42 that mates with the step boss 23; the end face of the plug is provided with a plurality of circularly-arranged first carrier rings 40a that are coupled to the outlet of the first plastic feeding pipe 20a; the step surface of the plug is provided with a plurality of circularly-arranged second carrier rings 40b that are coupled to the outlet of the second plastic feeding pipe 20b; the center of the plug is provided with a center bore 2 that is coupled to the center bore of the fixed mould; the inner of the carrier disc 40 is provided with the first runner 41a that is in communication with the front end face of the carrier disc and the first carrier ring 40a, and the inner of the carrier disc is provided with the second runner 41b that is in communication with the front end face of the carrier disc and the second carrier ring 40a. When the spinning block rotates, the first and second carrier rings align the first and second plastic feeding pipes (20a, 20b) of the fixed mould 20, so that the first and second carrier rings can continuously obtain first and the second plastics. Referring to the front view and section view of the nozzle 50 in FIG. 10 and FIG. 11, the rear end of the nozzle 50 is a thick and flat cylinder 51; the rear end face is dimpling in, to inlay the carrier disc (the outer periphery of the carrier disc is provided with threads to thread joint the hollow part at the rear end of the nozzle); the rear of the nozzle 50 is provided with a cambered first runner trough 51a that is coupled to the outlet of the first runner 41a and a cambered second runner trough 51b that is coupled to the outlet of the second runner 41b; the center of the nozzle is coupled to the center bore of the carrier disc; the first runner trough 51a and the second runner trough 51b are provided with grooves 52 that are coupled to the center bore of the nozzle 50; the front end of the nozzle 50 is a vimineous cylinder 53 that goes through the outside of the mould temperature cap 30, and the outer periphery is socketed with the gear 3; the first carrier ring 40a, the first runner 41a, the first runner trough 51a, and groove 52 form the first feeding channel, and the second carrier ring 40b, the second runner 41b, the second runner trough 51b, and groove 52 form the second feeding channel. FIG. 12 shows the schematic of the connection between the carrier disc and the nozzle.

In a preferred embodiment, the side wall of the mould temperature cap 30 is provided with the pipeline 4 that is used for circulating hot oil. The external mould temperature controller pumps hot oil to the pipeline for circulating, thus providing necessary heating to the spinning block, keeping the insulation plastics in the plasticized state, and avoiding hardening during extrusion.

To reduce vibration and friction of the spinning block, as shown in FIG. 1, the bearing comprises a tapered roller bearing 60, a first thrust ball bearing 61, and a second thrust ball bearing 62; wherein: the first thrust ball bearing is fixed between the front end face of the fixed mould 20 and the read end face of the spinning block 9; the tapered roller bearing is fixed between the inner side wall of the mould temperature cap 30 and the outer side wall at the front end of the nozzle 50; the second thrust ball bearing 62 is fixed between the front end face at the rear end of the nozzle 50 and the rear end face of the tapered roller bearing 60.

In a preferred embodiment, the inner wall at the rear end of the mould temperature cap 30 and the outer periphery of the fixed mould 20 are provided with threads and are thread jointed together; the outer periphery of the fixed mould 20 is thread jointed with a mould clamping ring 5; the mould clamping ring (5) tightly abuts against the rear end face of the mould temperature cap 30 to avoid looseness during working

In preferred embodiments illustrated in FIG. 1 and FIG. 6, a first feeding inlet 21a and a second feeding inlet 21b are provided with female threads. The female threads can be conveniently coupled to the pipelines of the first and second plastics (the external pipelines are not shown in the figures).

The above described embodiments are only examples, not limitations.

All equivalent modifications or changes without departing from the spirit of the present invention are covered in by the claims of the present invention.

What is claimed is:

1. An injection molding device for wrapping wires with three-color spiral insulation layers, comprising a spinning block (9), a fixed mould (20), and a handpiece (15) that are coaxially mounted, wherein: each of axes of these three components is provided with a center bore (2) for wires (1) passing through; a spinning block is entangled by a mould temperature cap (30), the rear end of the mould temperature cap (30) being coupled to an outer periphery of the fixed mould (20); a front end of the spinning block (9) goes through a front end of the mould temperature cap (30) and an outer periphery of the spinning block (9) is socketed by a gear (3); a bearing is arranged between the mould temperature cap (30) and the spinning block (9); the spinning block (9) rotates around the axes with the rotation of the gear (3); a third plastic feeding pipe (10c) is arranged between a side wall of the handpiece (15) and a center bore thereof; a first plastic feeding pipe (20a) and a second plastic feeding pipe (20b) are arranged between a side wall of the fixed mould (20) and a front end face thereof; a rear end face of the spinning block (9) is provided with a first carrier ring (40a) that is coupled to the first plastic feeding pipe (20a) and a second carrier ring (40b) that is coupled to the second plastic feeding pipe (20b); a first feeding channel is arranged between the first carrier ring (40a) and the center bore at the axes of the spinning block (9); and a second feeding channel is arranged between the second carrier ring (40b) and the center bore at the axes of the spinning block (9).

2. The injection molding device for wrapping wires with three-color spiral insulation layers according to claim 1, wherein: the handpiece (15) comprises a coaxially-mounted movement (11), an internal mould (12), and a handpiece body (13) that is socketed on the movement outer periphery; and the wire goes through the axes of these three components, wherein:
the center of the movement (15) is a round bore, the outer periphery of the movement (15) is conical, the front end of the movement (15) is small and the rear end of the movement (15) is large, the front end of the movement (15) and the internal mould (12) are in a thread joint structure;
the center of the internal mould (12) is a conical bore, the outer periphery of the internal mould (12) is conical, the front end of the internal mould (12) is small and the rear end of the internal mould (12) is large, the internal mould (12) is inserted in the fixed mould (20);
the inner periphery of the handpiece body (13) is a conical bore that mates with the outer periphery of the movement (15), the outer periphery of the handpiece body (13) is square, the side wall of the handpiece body (13) is provided with a third feeding inlet (13c) that is coupled to the third plastic feeding pipe (10c); a space is reserved between the inner periphery of the handpiece body (13) and the outer periphery of the movement (15); a space is reserved between the inner periphery of the fixed mould (20) and the outer periphery of the internal mould (12); two spaces form the third plastic feeding pipe (10c).

3. The injection molding device for wrapping wires with three-color spiral insulation layers according to claim 2, wherein: the center of the fixed mould (20) is a conical bore that mates with the outer periphery of the internal mould (12); the outer periphery of the fixed mould (20) is cylindric, the side wall is provided with a first feeding inlet (21a) that is coupled to the first plastic feeding pipe (20a) and a second feeding inlet (21b) that is coupled to the second plastic feeding pipe (20b); the front end of the fixed mould (20) is provided with a circinate step boss (23); the outside of the step boss (23) is provided with a tubular check ring (22); a circinate plane is reserved between the step boss (23) and the check ring (22), and the outlet of the first plastic feeding pipe (20a) is arranged on the circinate plane; the outlet of the second plastic feeding pipe (20b) is arranged on a step surface of the step boss (22); the center of the step boss (22) is the center bore (2) which the wires pass through.

4. The injection molding device for wrapping wires with three-color spiral insulation layers according to claim 3, wherein: the spinning block (9) comprises a carrier disc (40) and a nozzle (50), wherein:
a main body of the carrier disc (40) is cylindric; a rear end of the carrier disc is provided with a cylindric plug that is insertable into the check ring (22); the center of the plug is provided with a step bore (42) that mates with the step boss (23); an end face of the plug is provided with a plurality of circularly-arranged first carrier rings (40a) that are coupled to the outlet of the first plastic feeding pipe (20a); the step surface of the plug is provided with a plurality of circularly-arranged second carrier rings (40b) that are coupled to the outlet of the second plastic feeding pipe (20b); the center of the plug is provided with a center bore (2) that is coupled to the center bore of the fixed mould (20); the inner of the carrier disc (40) is provided with a first runner (41a) that is in communication with the front end face of the carrier disk and the first carrier ring (40a), and the inner of the carrier disc (40) is provided with a second runner (41b) that is in communication with the front end face of the carrier disc and the second carrier ring (40b);
a rear end of the nozzle (50) is a thick and flat cylinder (51); the rear end face of the nozzle (50) is dimpling in, to inlay the carrier disc (40); the rear of the nozzle is provided with a cambered first runner trough (51a) that is coupled to an outlet of the first runner and a cambered second runner trough (51b) that is coupled to an outlet of the second runner; the center of the nozzle is coupled to a center bore of the carrier disc (40); the first runner trough (51a) and the second runner trough (51b) are provided with grooves (52) that are coupled to a center bore of the nozzle (50); a front end of the nozzle (50) is a vimineous cylinder (53) that goes through the outside of the mould temperature cap (30), and an outer periphery of the nozzle (50) is socketed with the gear (3); the first carrier ring (40a), the first runner (41a), the first runner trough (51a), and grooves (52) form the first feeding channel, and the second carrier ring (40b), the second runner (41b), the second runner trough (51b), and grooves (52) form the second feeding channel.

5. The injection molding device for wrapping wires with three-color spiral insulation layers according to claim 1, wherein: the side wall of the mould temperature cap (30) is provided with a pipeline (4) that is used for circulating hot oil.

6. The injection molding device for wrapping wires with three-color spiral insulation layers according to claim 1, wherein the bearing comprises a tapered roller bearing (60), a first thrust ball bearing (61), and a second thrust ball bearing (62); wherein: the first thrust ball bearing (61) is fixed between a front end face of the fixed mould (20) and a rear end face of the spinning block; the tapered roller bearing (60) is fixed between an inner side wall of the mould temperature cap (30) and an outer side wall at a front end of the nozzle (50); the second thrust ball bearing (62) is fixed between the front end face at a rear end of the nozzle (50) and the rear end face of the tapered roller bearing (60).

7. The injection molding device for wrapping wires with three-color spiral insulation layers according to claim 1, wherein the inner wall at a rear end of the mould temperature cap (30) and an outer periphery of the fixed mould (20) are provided with threads and are thread jointed together; the outer periphery of the fixed mould is thread jointed with a mould clamping ring (5); the mould clamping ring (5) tightly abuts against on the rear end face of the mould temperature cap.

8. The injection molding device for wrapping wires with three-color spiral insulation layers according to claim 3, wherein the first feeding inlet (21a) and the second feeding inlet (21b) are provided with female threads.

9. A three-color spiral wire, comprising an enamelled wire set and an insulation layer outside the enamelled wire set, wherein the insulation layer is spirally winded around as a cylinder by three-color insulation materials.

10. The three-color spiral wire according to claim 9, wherein the insulation material outside the enamelled wire set is thermoplastic material.

11. The three-color spiral wire according to claim 10, wherein the thermoplastic materials are thermoplastic elastomer (TPE), polyethylene (PE), and polypropylene (PP).

12. The three-color spiral wire according to claim 9, wherein the enamelled wire set comprises solid or tubular copper wires, tinned copper wires, or multiple twisted thin copper wires.
